(19) United States
(12) Patent Application Publication
(10) Pub. No.: US 2026/0176104 A1
(43) Pub. Date: Jun. 25, 2026

(54) ELEVATOR REMOTE MAIN LINE DISCONNECT DEVICE AND SYSTEM

(71) Applicant: Yury Novak, Staten Island, NY (US)

(72) Inventor: Yury Novak, Staten Island, NY (US)

(21) Appl. No.: 19/000,824

(22) Filed: Dec. 24, 2024

(51) Int. Cl. B66B 5/00; B66B 5/02

(52) U.S. Cl. CPC B66B 5/005; B66B 5/021

(57) ABSTRACT

A device, system, and method for temporarily disconnecting electrical power in an elevator, the device, system, and method including an elevator controller electrically coupled to a power grid via at least one electrical power line, a transformer electrically coupled to the at least one incoming electrical power line, the transformer reducing a voltage to a second electrical line from the incoming electrical power line, and a remote disconnect switch electrically coupled to the transformer via the second electrical line and moveable between a closed position and a disconnect position, with the remote disconnect switch disabling electrical power to the elevator controller when in the disconnect position.

### TECHNICAL FIELD

The present invention relates to devices and systems for remotely disconnecting main electrical lines of electrically-powered elevators.

### BACKGROUND OF THE INVENTION

For many decades, elevators have served as essential fixtures in commercial, residential and industrial buildings, ferrying people and materials between floors and making possible the vertical expansion of cities. Since the introduction of elevators, safety has been a primary concern in the design and installation of elevators. Innovation in elevator safety includes devices such as Elisha Otis'safety brake intended to keep an elevator car from plummeting in the event of a broken hoist rope. One key element of elevator safety is the proper maintenance of elevators by technicians, mechanics, inspectors, and other authorized personnel; these authorized personnel may be exposed to dangerous situations while maintaining the elevators.

Elevators are large structures with a main elevator controller often located in a machine or maintenance room such that the main elevator controller is separate and remote from the elevator that needs maintenance. Occupational Safety and Health Administration (“OSHA”) guidelines require that authorized personnel only perform maintenance on an elevator equipment when such equipment is completely disconnected from electrical power, i.e., de-energized. Thus, authorized personnel must often first go to the location of the main elevator controller and shut down power to a desired elevator before they may begin maintenance on that elevator.

Authorized personnel are generally assigned to work on elevators alone. To de-energize a desired elevator, authorized personnel must travel between the elevator and the location of the main elevator controller, even for work requiring the elevator to be de-energized temporarily for short time periods, e.g., for 1 to 5 minutes. For authorized personnel not familiar with the particular wiring setup of an elevator, it may be easy to turn off the switch at the elevator controller and not completely de-energize the desired elevator. Such issues are particularly problematic when a single authorized person is assigned to work at a building with multiple elevators. This can lead to authorized personnel believing they have de-energized an elevator, when in fact they have not. Business concerns, such as deadlines and efficiency goals, may also cause authorized personnel to perform maintenance in an unsafe manner.

All of these issues are known within the elevator industry to cause authorized personnel to work on live circuits and elevator equipment that unexpectedly moves. Performing maintenance work under such conditions may potentially damage property and put authorized personnel at risk of injury or even death. Accordingly, there is a need in the art for devices, systems, or methods that make the maintenance of elevators safer and more efficient.

### SUMMARY OF THE INVENTION

In general, in one aspect, the invention features a device for temporarily disconnecting electrical power in an elevator, the device including at least one remote disconnect switch electrically coupled to a transformer via a first electrical line and moveable between a closed position and a disconnect position, wherein the transformer is electrically coupled to at least one incoming electrical power line, the transformer configured to reduce a voltage to the first electrical line from the at least one incoming electrical power line, and
wherein the at least one remote disconnect switch is configured to disable electrical power to an elevator controller that is electrically coupled to the at least one incoming electrical power line when the at least one remote disconnect switch is in the disconnect position.

Implementations of the invention may include one or more of the following features. The device may include a relay electrically coupled to the at least one incoming electrical power line, with the relay configured to disable electrical power in the at least one incoming electrical power line when at least one of phase loss, phase rotation, or power loss is sensed by the relay in the at least one incoming electrical power line. The relay may further have a contact for each line of the at least one incoming electrical line. The device may include a first fuse placed on the first electrical line between the transformer and the at least one remote disconnect switch. The device may include a second fuse placed on the electric coupling between the transformer and the at least one incoming electrical line. The at least one disconnect switch may include a plurality of disconnect switches arranged in series on the first electrical line. The device may have a relay that is electrically coupled to the first electrical line via a contact, with the relay disabling the plurality of disconnect switches when at least one of phase loss, phase rotation, or power loss is sensed by the relay in the first electrical line. The device may include at least one indicator that corresponds to the at least one disconnect switch. The at least one indicator may be a light emitting diode configured to illuminate when the at least one disconnect switch is in a disconnect position. The at least one indicator may be placed on a second electrical line with a relay contact configured to connect the at least one electrical indicator to electrical power when the at least one disconnect switch is placed into a disconnect position.

In general, in another aspect, the invention features a system for temporarily disconnecting electrical power in an elevator, the system including an elevator controller electrically coupled to a power grid via at least one electrical power line, a transformer electrically coupled to the at least one incoming electrical power line, the transformer configured to reduce a voltage to a second electrical line from the incoming electrical power line, and at least one remote disconnect switch electrically coupled to the transformer via the second electrical line and moveable between a closed position and a disconnect position, with the at least one remote disconnect switch being configured to disable electrical power to the elevator controller when in the disconnect position.

Implementations of the invention may include one or more of the following features. The system may include a relay electrically coupled to the at least one incoming electrical power line, with the relay being configured to disable electrical power in the at least one incoming electrical power line when at least one of phase loss, phase rotation, or power loss is sensed by the relay in the at least one incoming electrical power line. The relay may include a contact for each line of the at least one incoming electrical line. The system may have a first fuse placed on the first electrical line between the transformer and the at least one remote disconnect switch. The system may have a second fuse is placed on the electric coupling between the transformer and the at least one incoming electrical line. The at least one disconnect switch may include a plurality of disconnect switches placed in at least one of an elevator controller, an elevator pit, an elevator car, an elevator overhead space, and an elevator machine room. The at least one disconnect switch may include a plurality of disconnect switches, and the placement of any one of the plurality of disconnect switches into a disconnect position disables electrical power to a remainder of the plurality of disconnect switches. Each of the plurality of disconnect switches may include an indicator, and the placement of any one of the plurality of disconnect switches into a disconnect position may cause each indicator to show each of the plurality of disconnect switches as being in a disconnect position. The system may include at least one indicator that corresponds to the at least one disconnect switch. The at least one indicator is a light emitting diode configured to illuminate when the at least one disconnect switch is in a disconnect position.

### BRIEF DESCRIPTION OF THE DRAWINGS

FIG. 1 shows a schematic diagram of the placement of the remote main line disconnect device within an elevator in accordance with an embodiment of the present invention;

FIG. 2 shows an electrical diagram of a remote main line disconnect device in accordance with an embodiment of the present invention;

FIG. 3A-3C shows the placement of switches of the remote main line disconnect device relative to elevator controllers in accordance with embodiments of the present invention; and

FIG. 4 shows a flow chart of the operation for the remote main line disconnect device in accordance with embodiments of the present invention.

### DETAILED DESCRIPTION OF THE INVENTION

Supplemental elevator components, devices, systems, and methods of operation are described herein, with reference to examples and exemplary embodiments. Specific terminology is employed in describing examples and exemplary embodiments. However, the disclosure of this patent specification is not intended to be limited to the specific terminology so selected and it is to be understood that each specific elements includes all technical equivalents that operate in a similar manner.

The present invention is directed to devices and systems for remotely disconnecting main electrical lines of elevators temporarily. In a preferred embodiment, remote main line disconnect devices are placed at critical locations of an elevator system, thereby providing authorized personnel the ability to disconnect the elevator from electrical power without needing to use a main elevator controller.

With reference to the figures, the reference characters utilized in the figures and discussed below are:
10=Machine Room.
20=Elevator Controller.
30=Elevator Motor.
40=Elevator Overhead Space.
50=Elevator Shaft.
60=Elevator Pit.
70=Elevator Car.
102=L1: 1^{st} terminal from three-phase 208 VAC power distribution.
104=L2: 2^{nd} terminal from three-phase 208 VAC power distribution.
106=L3: 3^{rd} terminal from three-phase 208 VAC power distribution.
108=LA: “A” terminal—connection with elevator controller.
110=LB: “B” terminal—connection with elevator controller.
112=LC: “C” terminal—connection with elevator controller.
114=RPR: three-phase control & safety protection “Reverse Phase Relay” 208 VAC, including a coil and normally open dry contact.
116/118=F1/F2: Fuses for protection of a 208/24 VAC stepdown transformer.
120=208VAC/24VAC: stepdown transformer
122/124/126/128/130=A: contactor, including a 24VAC coil, three contacts for three-phase in-line connectors L1/LA,
L2/LB, L3/LC and an auxiliary normally closed dry contact for LED indicators circuit.
132=Cn: Manual switch at elevator controller.
134=Pit: Manual switch in elevator pit.
136=Tpc: Manual switch on top of car.
138=Ovh: Manual switch in elevator overhead.
140=Mch: Manual switch in elevator machine space.
142/144/146/148/150=1, 2, 3, 4, 5: Terminal point

connections for related manual switches. In cases where the manual switch between terminals is not available - these are to be connected with permanent jumper wire.
152=Lcn: LED light indicator for manual switch at elevator controller.
154=Lpit: LED light indicator for manual switch at elevator

pit.
156=Ltpc: LED light indicator for manual switch at top of the car.
158=Lovh: LED light indicator for manual switch at elevator overhead space.
160=Lmch: LED light indicator for manual switch at elevator separate machine space.
162/164/166/168/170=R: load resistors for LED light indicators.

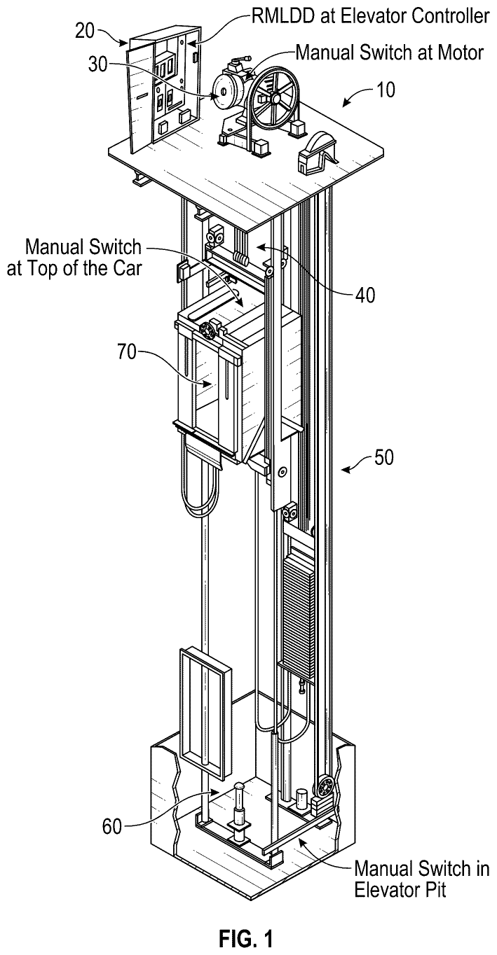

Referring now to the figures, FIG. 1 shows an elevator incorporating a remote main line disconnect device (RMLDD) of the present invention. Elevator maintenance is typically performed in specific locations in and around an elevator, including a machine room 10 housing an elevator controller 20 and an elevator motor 30, an elevator overhead space 40 at a top of an elevator shaft 50, an elevator pit 60 at a bottom of the elevator shaft 50, and an elevator car 70. These locations and components are the critical to elevator maintenance, as most elevator equipment requiring maintenance is accessible in these locations. When performing maintenance, authorized personnel must first shut down electrical power to the elevator temporarily. This generally requires traveling to the machine room 10 and selecting an appropriate switch on the elevator controller 20 to de-energize the desired elevator. However, this is time-consuming and can lead to errors where an authorized person believes he has powered down an elevator when in fact he has not, particularly when the authorized person is working alone or on an unfamiliar elevator.

In an exemplary embodiment of the present invention, remote disconnect switches 132, 134, 136, 138, 140 of the RMLDD may be placed on the elevator controller 20, on the elevator motor 30, in the elevator overhead space 40, in the elevator pit 60, and at the top of the elevator car 70. Placing the remote disconnect switches 132, 134, 136, 138, 140 in these locations allows authorized personnel to quickly and safely disconnect an elevator from electrical power temporarily when performing maintenance. The remote disconnect switches 132, 134, 136, 138, 140 enable authorized personnel to avoid going between multiple locations to power down a desired elevator and eliminates errors in switch selection at the elevator controller.

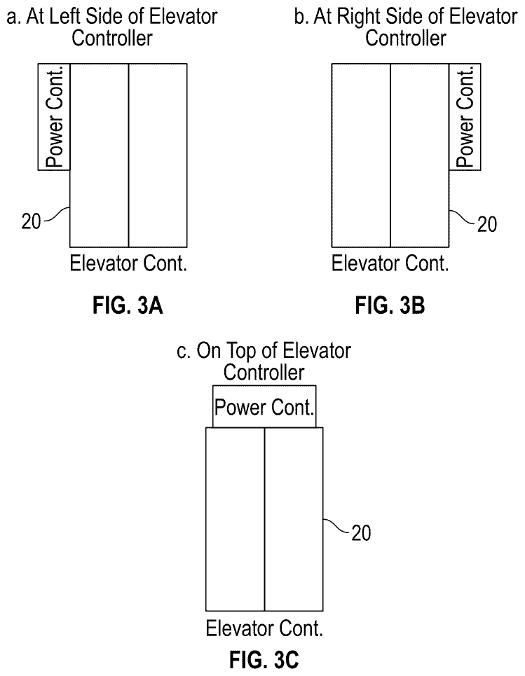

In a preferred embodiment, a primary remote disconnect switch 132 is placed on and electrically connected to the elevator controller 20. As seen in FIGS. 3A-3C, the primary remote disconnect switch 132 may be attached to the elevator controller 20 for convenient access wherever the elevator controller 20 is located. Each of the remote disconnect switches 132, 134, 136, 138, 140 may include a respective LED indicator 152, 154, 156, 158, 160 to inform authorized personnel that the elevator is powered down.

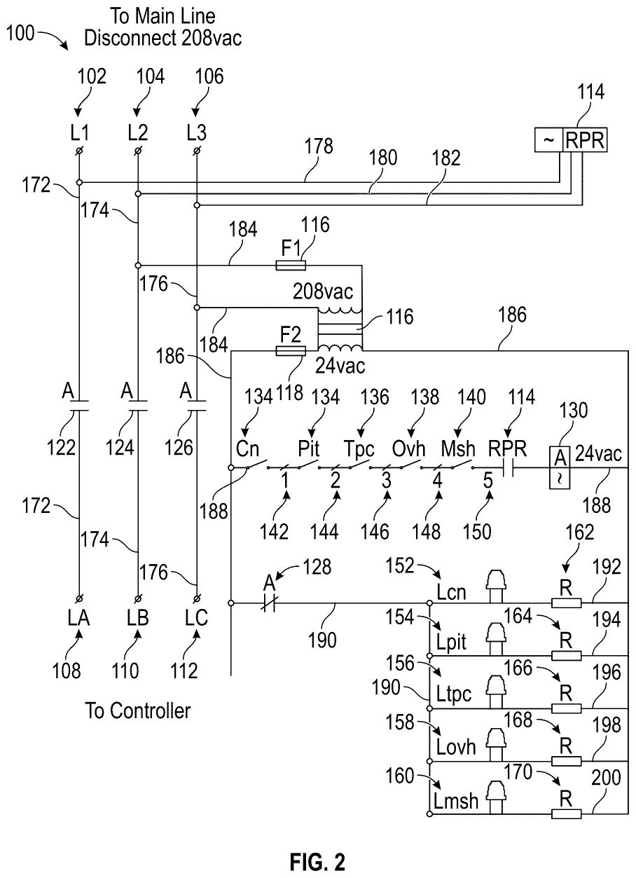

An electrical diagram of a preferred embodiment of an RMLDD in accordance with the present invention is shown in FIG. 2. A plurality of incoming terminals 102, 104, 106 connect the RMLDD to the main power line for an elevator, such as a three-phase 208 Volts Alternating Current (VAC) power distribution electrical line. The incoming terminals 102, 104, 106 are electrically coupled to corresponding elevator controller terminals 108, 110, 112 via corresponding contacts 122, 124, 126 of a contactor 130 and corresponding electrical lines 172, 174, 176.

A Reverse Phase Relay (RPR) 114 is electrically coupled to the electrical lines 172, 174, 176. In some embodiments, the RPR 114 is connected to the electrical lines 172, 174, 176 between the incoming terminals 102, 104, 106 and the corresponding contacts 122, 124, 126. The RPR 114 monitors the electrical lines 172, 174, 176, and disables the electrical power connection to the RMLDD when there is a power loss, phase loss, or phase rotation in the main power line. This allows the RPR 114 to protect the RMLDD system from damage. The RPR 114 may be formed of any suitable industry standard electromagnetic relay, such as a coil relay with a normally open dry contact. In an exemplary embodiment, the RPR 114 may be formed of a coil of wire wrapped around a soft iron core (i.e., a solenoid), an iron yoke that acts as a path for magnetic flux, a movable armature, and a set of isolated (i.e., dry) contacts. In exemplary embodiments, the RPR may be formed as a single-pole double throw (SPDT) relay, a double-pole double throw (DPDT) relay, a four-pole double throw (4PDT) relay, or other relay types as defined by the Relay and Switch Industry Association.

A stepdown transformer 120 is electrically coupled to at least two of the electrical lines 172, 174, 176 via an electrical line 184. The stepdown transformer 120 is further electrically coupled to a separate electrical line 186. The separate electrical line 186 connects the disparate components of the RMLDD to the elevator controller 20 and main power line via the stepdown transformer 120. The stepdown transformer 120 enables the RMLDD to run on the separate electrical line at a low voltage, e.g., 24 VAC, known to be safe for authorized personnel. A first fuse 116 is placed on the electrical line 184 and a second fuse 118 is placed on the separate electrical line 186. The first and second fuses 116, 118 protect the stepdown transformer 120 from excessive electrical currents.

The separate electrical line 186 is electrically connected to electrical lines 188 and 190. The electrical line 188 provides electrical power to the remote disconnect switches 132, 134, 136, 138, 140. In some embodiments, the remote disconnect switches 132, 134, 136, 138, 140 may be arranged in series along electrical line 188. The remote disconnect switches 132, 134, 136, 138, 140 allow authorized personnel to manually disconnect the elevator system from the main power line at the location where the authorized personnel needs to perform maintenance. In an exemplary embodiment, the remote disconnect switches 132, 134, 136, 138, 140 allow the RMLDD to disconnect power at the elevator controller 20, in the elevator pit 60, at the top of the elevator car 70, in the elevator overhead space 40, and in the machine room 10, respectively.

In an exemplary embodiment of the present invention, terminal point connections 142, 144, 146, 148, 150 are placed in series along the electrical line 188 between each of the remote disconnect switches 132, 134, 136, 138, 140. Each of the terminal point connections 142, 144, 146, 148, 150 enables one of the remote disconnect switches 132, 134, 136, 138, 140 to electrically couple to another one of the remote disconnect switches 132, 134, 136, 138, 140. In some embodiments, a remote disconnect switch 132, 134, 136, 138, 140 may not appear between terminal point connections 142, 144, 146, 148, 150 along electrical line 188. In such instances, an electrical connection means, for example, a permanent jumper wire, may be used to connect terminal point connections 142, 144, 146, 148, 150.

The RPR 114 may also be connected to electrical line 188 to monitor and disable the electrical power connection in electrical line 188 when there is a power loss, phase loss, or phase rotation in the main power line. The RPR 114 connection may be formed of a suitable relay, such as a normally open dry contact.

In a preferred embodiment, a coil of contactor 130 is electrically connected to electrical line 188. The coil of contactor 130 is designed to operate at the voltage rating of electrical line 188, e.g., 24 VAC. Further, the coil of contactor 130 detects when one of the remote disconnect switches 132, 134, 136, 138, 140 is placed into a disconnect position, e.g., opened by authorized personnel from a normally closed state. Upon detection of a remote disconnect switch being in the disconnect position, the coil of contactor 130 becomes deenergized. Contactor 130 then moves contacts 122, 124, 126 into disengaged positions such that electrical power to the elevator controller 20 is cut off.

In an exemplary embodiment, electrical line 190 provides the electrical power from electrical line 186 to indicators 152, 154, 156, 158, 160. Each of the indicators 152, 154, 156, 158, 160 may be arranged in parallel relative to one another and have its own electrical line 192, 194, 196, 198, 200, respectively. In operation, the indicators 152, 154, 156, 158, 160 provide a signal to authorized personnel that the elevator is electrified and operational or that the elevator is de-energized, such as by operation of the RMLDD system. The indicators 152, 154, 156, 158, 160 may be formed by any suitable means for providing visual, audible, or tactile confirmation that the RMLDD has been engaged to de-energize the elevator or not. For example, the indicators 152, 154, 156, 158, 160 may be formed as light emitting diodes (LEDs) placed on or near the remote disconnect switches 132, 134, 136, 138, 140. A load resistor 162, 164, 166, 168, 170 may further be provided along each of the electrical lines 192, 194, 196, 198, 200 to stabilize the operation of indicators 152, 154, 156, 158, 160, particularly where the indicators 152, 154, 156, 158, 160 are formed as LEDs.

Electrical line 190 may further include an auxiliary contact 128 of contactor 130. The auxiliary contact 128 is arranged to energize indicators 152, 154, 156, 158, 160 when the coil of contactor 130 is de-energized following placement of one of the remote disconnect switches 132, 134, 136, 138, 140 into a disconnect position. In a preferred embodiment, the auxiliary contact 128 may be formed by a normally closed dry contact.

In exemplary embodiments, the RMLDD system may operate in two modes, a normal mode and a disconnect mode. In the normal mode, the remote disconnect switches 132, 134, 136, 138, 140 are in placed in a closed position, thereby completing the circuit created by electrical lines 186 and 188 and causing the coil of contactor 130 to be energized. The contacts 122, 124, 126 may be arranged to be closed while the coil of the contactor 130 is energized. With the contacts 122, 124, 126 closed, the electrical lines 172, 174, 176 electrically couple incoming terminals 102, 104, 106 and elevator controller terminals 108, 110, 112, enabling the elevator to operate as instructed by the elevator controller 20. During this normal mode of operation, the RPR 114 monitors the electrical lines 172, 174, 176 for power loss, phase loss, phase rotation. If the RPR 114 detects these conditions, the RPR 114 becomes de-energized and disables electrical power to the control circuit of the RMLDD system to prevent damage.

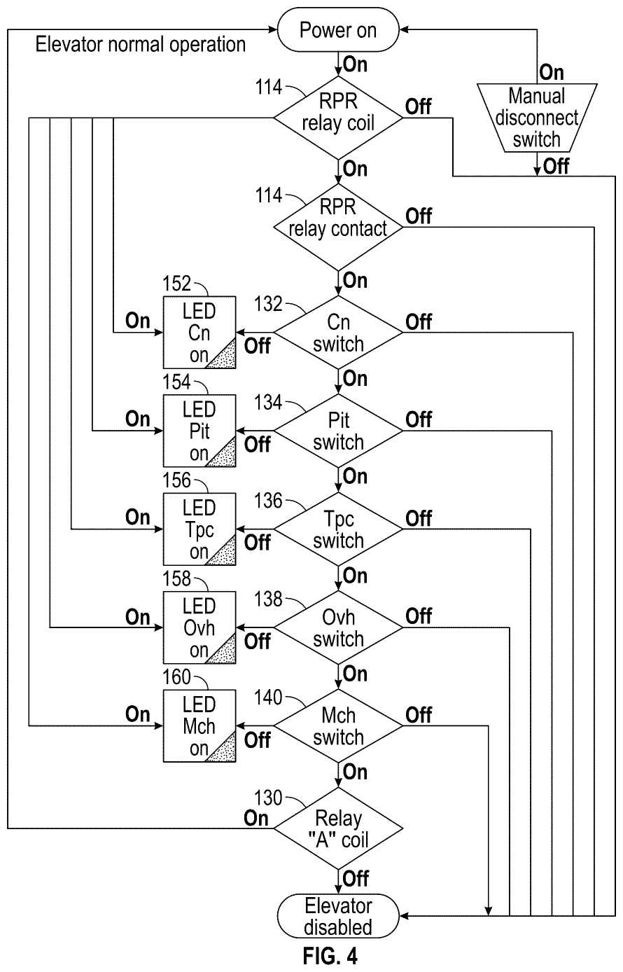

As can be seen in FIGS. 2 and 4, the disconnect mode of operation is initiated when at least one of the remote disconnect switches 132, 134, 136, 138, 140 or the relay contact of the RPR 114 is moved into the disconnect position. This de-energizes the coil of contactor 130 and causes the contacts 122, 124, 126 to open and cut off power to the elevator controller terminals 108, 110, 112, shutting down the elevator controller. The de-energized coil of contactor 130 further causes auxiliary contact 128 to complete the circuit created by electrical lines 186 and 190. This provides electrical power to indicators 152, 154, 156, 158, 160 so that authorized personnel are notified that the elevator controller is powered down. The authorized personnel are thus able to begin maintenance on portions of the elevator without fear of the elevator still being operational and suddenly moving or causing potentially fatal electrocution.

Once maintenance is complete, the authorized personnel may restore the RMLDD to normal mode operation by moving each remote disconnect switch 132, 134, 136, 138, 140 that is in the disconnect position to the closed position. The coil of contactor 130 is thus re-energized, causing the contacts 122, 124, 126 to close and restore power to the elevator controller terminals 108, 110, 112, and causing the auxiliary contact 128 to move into an open position to disconnect indicators 152, 154, 156, 158, 160 from electrical power.

The present invention thus resolves safety problems for elevator authorized personnel. The RMLDD of the present invention allows authorized personnel to manually de-energize electrical power for an elevator from critical maintenance locations that are remote from the elevator controller. The RMLDD thereby eliminates the chance of authorized personnel mistakenly leaving electrical power on for elevator components they are about perform maintenance work on. Elevator maintenance safety is thus improved and the possibility of property damage, injury, or death is mitigated.

The embodiments and examples above are illustrative, and many variations can be introduced to them without departing from the spirit of the disclosure or from the scope of the appended claims. For example, elements and/or features of different illustrative and exemplary embodiments herein may be combined with each other and/or substituted with each other within the scope of this disclosure. For a better understanding of the invention, its operating advantages and the specific objects attained by its uses, reference should be had to the accompanying drawings and descriptive matter in which there are illustrated exemplary embodiments of the invention.

What is claimed is:

1. A device for temporarily disconnecting electrical power in an elevator, the device comprising:
at least one remote disconnect switch electrically coupled to a transformer via a first electrical line and moveable between a closed position and a disconnect position;
wherein the transformer is electrically coupled to at least one incoming electrical power line, the transformer configured to reduce a voltage to the first electrical line from the at least one incoming electrical power line; and
wherein the at least one remote disconnect switch is configured to disable electrical power to an elevator controller that is electrically coupled to the at least one incoming electrical power line when the at least one remote disconnect switch is in the disconnect position.

2. The device of claim 1, further comprising a relay electrically coupled to the at least one incoming electrical power line, wherein the relay is configured to disable electrical power in the at least one incoming electrical power line when at least one of phase loss, phase rotation, or power loss is sensed by the relay in the at least one incoming electrical power line.

3. The device of claim 2, wherein the relay further comprises a contact for each line of the at least one incoming electrical line.

4. The device of claim 1, wherein a first fuse is placed on the first electrical line between the transformer and the at least one remote disconnect switch.

5. The device of claim 4, wherein a second fuse is placed on the electric coupling between the transformer and the at least one incoming electrical line.

6. The device of claim 1, wherein the at least one disconnect switch comprises a plurality of disconnect switches arranged in series on the first electrical line.

7. The device of claim 6, further comprising a relay that is electrically coupled to the first electrical line via a contact, wherein the relay disables the plurality of disconnect switches when at least one of phase loss, phase rotation, or power loss is sensed by the relay in the first electrical line.

8. The device of claim 1, further comprising at least one indicator that corresponds to the at least one disconnect switch.

9. The device of claim 8, wherein the at least one indicator is a light emitting diode configured to illuminate when the at least one disconnect switch is in a disconnect position.

10. The device of claim 8, wherein the at least one indicator is placed on a second electrical line with a relay contact configured to connect the at least one electrical indicator to electrical power when the at least one disconnect switch is placed into a disconnect position.

11. A system for temporarily disconnecting electrical power in an elevator, the system comprising:
an elevator controller electrically coupled to a power grid via at least one electrical power line;
a transformer electrically coupled to the at least one incoming electrical power line, the transformer configured to reduce a voltage to a second electrical line from the incoming electrical power line; and
at least one remote disconnect switch electrically coupled to the transformer via the second electrical line and moveable between a closed position and a disconnect position;
wherein the at least one remote disconnect switch is configured to disable electrical power to the elevator controller when in the disconnect position.

12. The system of claim 11, further comprising a relay electrically coupled to the at least one incoming electrical power line, wherein the relay is configured to disable electrical power in the at least one incoming electrical power line when at least one of phase loss, phase rotation, or power loss is sensed by the relay in the at least one incoming electrical power line.

13. The system of claim 12, wherein the relay further comprises a contact for each line of the at least one incoming electrical line.

14. The system of claim 11, wherein a first fuse is placed on the first electrical line between the transformer and the at least one remote disconnect switch.

15. The system of claim 14, wherein a second fuse is placed on the electric coupling between the transformer and the at least one incoming electrical line.

16. The system of claim 11, wherein the at least one disconnect switch comprises a plurality of disconnect switches placed in at least one of an elevator controller, an elevator pit, an elevator car, an elevator overhead space, and an elevator machine room.

17. The system of claim 16, wherein the at least one disconnect switch comprises a plurality of disconnect switches, and the placement of any one of the plurality of disconnect switches into a disconnect position disables electrical power to a remainder of the plurality of disconnect switches.

18. The system of claim 16, wherein each of the plurality of disconnect switches includes an indicator, and the placement of any one of the plurality of disconnect switches into a disconnect position causes each indicator to show each of the plurality of disconnect switches as being in a disconnect position.

19. The system of claim 11, further comprising at least one indicator that corresponds to the at least one disconnect switch.

20. The system of claim 18, wherein the at least one indicator is a light emitting diode configured to illuminate when the at least one disconnect switch is in a disconnect position.
